(19) United States
(12) Patent Application Publication
(10) Pub. No.: US 2017/0252253 A1
(43) Pub. Date: Sep. 7, 2017

(54) LOWER BODY AND SPINE JOINT MOVING DEVICE FOR RESTORING BODILY BALANCE, AND CONTROL METHOD THEREFOR

(71) Applicants: Hee Soo KIM, Hanam-si, Gyeonggi-do (KR); Medsapiens Co., LTD., Seongnam-si, Gyeonggi-do (KR)

(72) Inventor: Hee Soo KIM, Hanam-si, Gyeonggi-do (KR)

(73) Assignees: Medsapiens Co., LTD, Seongnam-si, Gyeonggi-do (KR); Hee Soo KIM, Hanam-si, Gyeonggi-do (KR)

(21) Appl. No.: 15/518,765

(22) PCT Filed: Oct. 14, 2015
(86) PCT No.: PCT/KR2015/010842

§ 371 Date: May 26, 2017

(30) Foreign Application Priority Data
Oct. 14, 2014 (KR) 10-2014-0138374

(51) Int. Cl. A61H 1/02

(52) U.S. Cl. CPC A61H 1/0292; A61H 1/024; A61H 2203/0456

(57) ABSTRACT

The present invention relates to a lower body and spine joint moving device for restoring bodily balance and a control method therefor. A lower body and spine joint moving device for restoring bodily balance according to an exemplary embodiment of the present invention includes: a bed which includes a torso supporter for supporting a user's torso and leg supporters for supporting the user's legs; a binding unit which fixes the user to the bed; and an actuator which generates power for extending and contracting the bed, in which each of the leg supporters includes an extending part which supports the user's leg and is extended and contracted in a longitudinal direction, and a curving part which forms a curvature and converts a movement in the longitudinal direction into a rotational motion of the extending part.

### TECHNICAL FIELD

The present invention relates to a lower body and spine joint moving device for restoring bodily balance and a control method therefor, and more particularly, to a lower body and spine joint moving device for restoring bodily balance and a control method therefor, which help a user's body to autonomously retain balance by restoring the user's joint to a normal position and relaxing the user's joint while protecting a ligament for stably holding the user's joint.

### BACKGROUND ART

There is Korean Patent No. 10-1061301 as a prior document related to the present invention, and the prior document discloses a technology about a physiotherapeutic traction device or a disc decompression therapeutic device capable of more effectively treating a medical condition occurring in treatment regions (lumbar vertebrae or cervical vertebrae) which are a waist or neck portion of a human body.

Mechanoreceptors refer to organs which are distributed on a joint and receive mechanical stimuli, that is, organs which create sensory signals in response to various types of physical stimuli applied to the body. A problem with the mechanoreceptor means that the mechanoreceptor cannot receive a proper biological signal about a muscle or a joint, and the joint needs to be normally positioned in order to normally receive a feedback signal. However, the joint is twisted due to a bad posture or the like, and because of the twist of the joint, the receptor cannot normally receive nervous stimuli transferred to the brain, and a normal nervous signal transmission ability deteriorates, and as a result, various types of problems occur in respect to a musculoskeletal system.

In general, a physiotherapeutic traction device uses traction or decompression in order to treat and correct pain of a disease such as a lumbar disc disorder, a cervical disc disorder, disc stenosis, chronic back pain, sciatica, or a lumbar displacement nervous disease, a cervical displacement nervous disease, which occurs in the lumbar vertebrae or the cervical vertebrae (a waist or neck portion) of the human body, and even in the related art, various types of physiotherapeutic traction devices are provided.

In the related art, in most instances, as a basic direct treatment method, joints, muscles, or muscle fasciae are directly corrected in a direction opposite to a direction in which the joint, the muscle, or the muscle fascia is twisted or compressed. In most instances, a manual therapeutic technique, which is performed by hand, directly corrects the joint in a direction opposite to a direction in which the joint is misaligned. The same applies to a disc traction therapeutic device which treats the cervical vertebrae and the lumbar vertebrae, and a disc decompression therapeutic device which performs the traction at slightly various angles of a therapeutic direction.

However, the physiotherapeutic traction devices in the related art are structurally made only for the purpose of performing the traction by pulling the human body, and as a result, there is a problem in that a patient's whole body is not corrected substantially smoothly, and a desired treatment purpose is not achieved. In addition, a traction moving device in the related art pulls a user's body in order to relax a joint, but in this case, there are problems in that stress is put on the user's body, a ligament is stretched, and as a result, pain rather increases.

### DISCLOSURE

### Technical Problem

The problems to be solved by the present invention are as follows.

First, an object is to enable a user to easily and conveniently perform exercise on lower limb joints and a whole body spine.

Second, another object is to relax the lower limb joints and the whole body spine while protecting ligaments of the user's joints.

Third, still another object is to help the human body to autonomously restore balance by normally inducing a feedback signal of a centripetal neurotransmission system on the brain by providing stimuli to mechanoreceptors of whole body joints of the human body by repeatedly performing compression and traction on the user's joints.

Fourth, yet another object is to efficiently supply nutrients into the joint (joint imbibition) as compressive force and tensile force are repeatedly applied onto the joint.

Technical problems of the present invention are not limited to the aforementioned technical problems, and other technical problems, which are not mentioned above, may be clearly understood by those skilled in the art from the following descriptions.

### Technical Solution

To achieve the aforementioned objects, a lower body and spine joint moving device for restoring bodily balance according to an exemplary embodiment of the present invention includes: a bed which includes a torso supporter for supporting a user's torso and leg supporters for supporting the user's legs; a binding unit which fixes the user to the bed; and an actuator which generates power for extending and contracting the bed, in which each of the leg supporters includes an extending part which supports the user's leg and is extended and contracted in a longitudinal direction, and a curving part which forms a curvature and converts a movement in the longitudinal direction into a rotational motion of the extending part.

In addition, a method of controlling a lower body and spine joint moving device for restoring bodily balance according to another exemplary embodiment of the present invention, which includes a bed that includes a torso supporter for supporting a user's torso and leg supporters for supporting the user's legs and capable of being bent at a knee position, a binding unit that fixes the user to the bed, and an actuator that generates power for extending and contracting the bed, includes: a fixing step of fixing the user to the bed with the binding unit; a bending step of bending the leg supporters in order to bend the user's knee; a compression step of applying compressive force to the user lying on the bed by decreasing a length of the bed while maintaining the bending step; and a traction step of applying tensile force to the user lying on the bed by extending a length of the bed while maintaining the bending step after the compression step.

In addition, a method of controlling a lower body and spine joint moving device for restoring bodily balance according to still another exemplary embodiment of the present invention, which includes a bed that includes a torso supporter for supporting a user's torso and leg supporters for supporting the user's legs and capable of being bent at a knee position, a binding unit that fixes the user to the bed, and an actuator that generates power for extending and contracting the bed, includes: a fixing step of fixing the user to the bed with the binding unit; a raising step of raising the leg supporter so that the user's leg is raised toward a front side of the user; a bending step of bending the leg supporters in order to bend the user's knee; a compression step of applying compressive force to the user lying on the bed by decreasing a length of the bed while maintaining the raising step and the bending step; and a traction step of applying tensile force to the user lying on the bed by extending a length of the bed while maintaining the raising step and the bending step after the compression step.

Other detailed matters of the exemplary embodiments are included in the detailed description and the drawings.

### Advantageous Effects

According to the present invention, there are effects as follows.

First, it is possible for the user to safely and conveniently perform joint exercise.

Second, it is possible to relax the joint while protecting the user's ligament.

Third, the user may easily and safely perform the joint exercise, and as a result, an old or weak person may also utilize the lower body and spine joint moving device.

Fourth, it is possible to supply nutrients into the joint (joint imbibition) as compressive force and tensile force are repeatedly applied onto the joint.

The effects of the present invention are not limited to the aforementioned effects, and other effects, which are not mentioned above, will be clearly understood by those skilled in the art from the claims.

### DESCRIPTION OF DRAWINGS

FIG. 1 is a view illustrating a skeleton structure of a human body, and ligaments disposed on a joint.

FIG. 2 is a perspective view of a lower body and spine joint moving device for restoring bodily balance and a control method therefor according to an exemplary embodiment of the present invention.

FIG. 3 is a block diagram according to the exemplary embodiment of the present invention.

FIG. 4 is a perspective view of leg supporters according to the exemplary embodiment of the present invention.

FIG. 5 is a perspective view illustrating a pivotal movement of the leg supporter according to the exemplary embodiment of the present invention.

FIG. 6 is a view illustrating rotations of a hip supporter and the leg supporter according to the exemplary embodiment of the present invention.

FIG. 7 is a flowchart illustrating the lower body and spine joint moving device for restoring bodily balance and the control method therefor according to the exemplary embodiment of the present invention.

FIG. 8 is a side view illustrating operations in a compression step and a traction step according to FIG. 7.

FIG. 9 is a flowchart illustrating a lower body and spine joint moving device for restoring bodily balance and a control method therefor according to another exemplary embodiment of the present invention.

FIG. 10 is a side view illustrating operations in a compression step and a traction step according to FIG. 9.

FIG. 11 is a view illustrating an operation that needs to be performed at the time of manipulative therapy in order to obtain the same effect as the effect obtained by the operation in FIG. 10.

FIG. 12 is a flowchart illustrating a lower body and spine joint moving device for restoring bodily balance and a control method therefor according to still another exemplary embodiment of the present invention.

FIG. 13 is a side view illustrating operations in a compression step and a traction step according to FIG. 12.

FIG. 14 is a view illustrating an operation that needs to be performed at the time of manipulative therapy in order to obtain the same effect as the effect obtained by the operation in FIG. 13.

FIG. 15 is a flowchart illustrating a lower body and spine joint moving device for restoring bodily balance and a control method therefor according to yet another exemplary embodiment of the present invention.

FIG. 16 is a top plan view illustrating operations in a compression step and a traction step according to FIG. 15.

### BEST MODE

Advantages and features of the present invention and methods of achieving the advantages and features will be clear with reference to exemplary embodiments described in detail below together with the accompanying drawings.

However, the present invention is not limited to the exemplary embodiments set forth below, and may be embodied in various other forms. The present exemplary embodiments are merely for rendering the disclosure of the present invention complete and are set forth to provide a complete understanding of the scope of the invention to a person with ordinary skill in the art to which the present invention pertains, and the present invention will only be defined by the scope of the claims. Throughout the specification, the same reference numerals denote the same constituent elements.

Hereinafter, the present invention will be described with reference to the drawings for explaining lower body and spine joint moving devices for restoring bodily balance and control methods therefor according to exemplary embodiments of the present invention. However, because an extending and contracting structure of a bed 10 or a rotational structure of the bed 10, which will be described below, may be easily carried out by the person skilled in the art by using various structures, a detailed description thereof will be omitted.

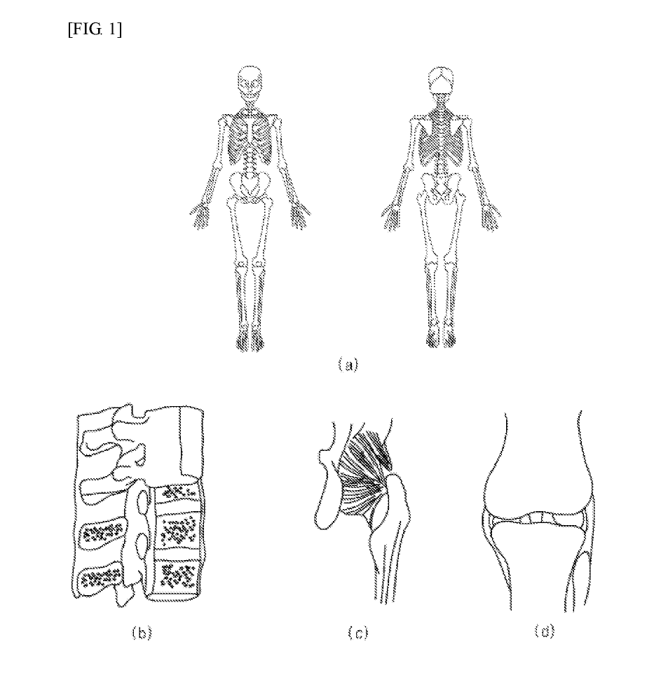

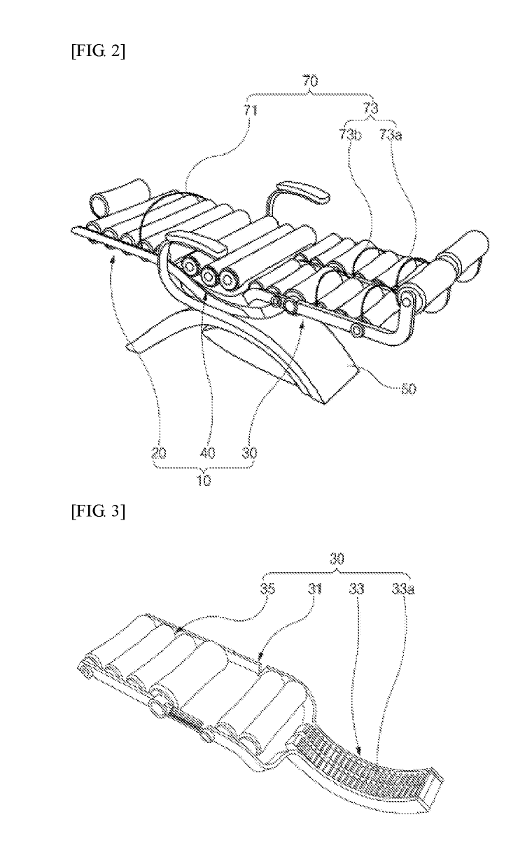

FIG. 1A illustrates a skeleton of a human body. FIG. 1B illustrates a spine and a spinal ligament. FIG. 1C illustrates a coxa and a coxal ligament. FIG. 1D illustrates a knee and a knee ligament. FIG. 2 is a perspective view of a lower body and spine joint moving device for restoring bodily balance according to an exemplary embodiment of the present invention. FIG. 3 is a block diagram according to the exemplary embodiment of the present invention.

Referring to FIGS. 1 to 3, the lower body and spine joint moving device for restoring bodily balance according to the exemplary embodiment of the present invention includes the bed 10 which supports a user, a binding unit 70 which fixes the user to the bed 10, and an actuator 80 which generates power for extending and contracting the bed 10 and repeatedly applies tensile force and compressive force to the user fixed by the binding unit 70 by repeatedly changing a direction of the power. The bed 10 may be elongated so that the user may lie thereon. The binding unit 70 is fixed to the bed 10, and fixes and tightly attaches the user onto the bed 10.

The actuator 80 may be a motor that converts electrical energy into rotational energy. The actuator 80 may transmit power to a plurality of gears, and the plurality of gears may extend and contract the bed 10. Since the user is fixed to the bed 10, the user's muscle is relaxed and pulled when the bed 10 is extended. In addition, when the bed 10 is contracted, the user's muscle is compressed. The compression and the traction are repeatedly performed by the actuator 80.

The extension of the bed 10 performs a stretching function. That is, the user's muscle and joint are relaxed, such that rigidity is reduced, and flexibility is increased. However, warming-up exercise is performed first before the traction, the traction is slowly and smoothly performed before and after exercise, and the muscle and the joint need to be pulled to a tension point within a range of where myalgia does not occur. The warming-up exercise helps improve a mind and body state so as to sufficiently increase an effect of the traction. Regarding basic kinetics of a coxa, a normal motion angle of the coxa when the coxa is bent is 80 degrees in a knee joint extended state, and 120 degrees in a knee joint bent state, and the motion angle is restricted when hamstring muscles, gracilis muscles, ischiofemoral ligaments, and inferior capsulars are shortened.

A normal angle of the coxa when the coxa is extended is 20 degrees in a knee joint extended state, and a normal motion angle is restricted when iliopsoas muscles, iliofemoral ligaments, and pubofemoral ligaments are shortened. The extension is 0 degree in a state in which the knee joint is bent, which restricts rectus femoris muscles.

A motion of the coxa, in which the coxa is spread at an angle of 40 degrees at the time of an external rotation, is normal, and the normal motion is restricted when adductors, hamstring muscles, pubofemoral ligaments, and inferior capsulars are shortened. An angle of 25 degrees is normal at the time of an internal rotation, and the normal motion is restricted when gluteus medias, musculus tensor fasciae latae, an iliotibial band, and an upper fiber of an the ischiofemoral ligament are adhered or shortened. A normal motion of the internal rotation of the coxa is 35 degrees, and the normal motion is restricted when external rotator muscles (piriform muscles, obturator internus, obturator externus, or superior inferior gemellus) and the ischiofemoral ligament are shortened.

A normal motion of the external rotation of the coxa is 45 degrees, and the normal motion is restricted when internal rotator muscles (gluteus medius, gluteus minimus, or musculus tensor fasciae latae), the iliofemoral ligament, and the iliotibial band are shortened. Therefore, flexibility of an operation, which restricts motions of the pelvis and the coxa which are a central axis of the human body, deteriorates because soft tissue such as muscles and ligaments at the periphery of the pelvis and the coxa is shortened, and the deterioration of the flexibility affects joints (particularly, a spine joint) of other portions such that a compensatory posture pattern is formed, and the compensatory pattern cannot make normal motions of respective organs, which causes various types of musculoskeletal diseases.

In general, the muscles, which maintain a posture among the muscles at the periphery of the coxa, are concentric muscles that are easily shortened. In particular, dual joint muscles, which run through two joints among the muscles, are postural muscles and concentric muscles. The muscles, such as the iliopsoas muscles which bend the coxae, the rectus femoris muscles, the gracilis muscles which are internally rotated, the hamstring muscles which are extended, the musculus tensor fasciae latae which are externally rotated, and the iliotibial bands, are representative concentric muscles that may be easily shortened. Therefore, when the compressive force and the tensile force are repeatedly applied onto the lower body and the spine joint, a position of the receptor of the spine joint, which receives a stimulus by a joint angle of the coxa, is changed, which needs to be considered at the time of joint exercise.

The compression helps the human body to autonomously restore balance normally inducing a feedback signal of a centripetal neurotransmission system on the brain by providing stimuli to the mechanoreceptors which are kinds of inherent proprioreceptor distributed on the joint of the human body (the user's joint). In addition, the compression is a warming-up exercise of the traction, and may also serve to awaken the user's attention, and correct a posture. Therefore, in a case in which the traction is performed immediately, injuries, such as withdrawal of the muscles or sprain of the ligaments which hold bones of the joint, are caused due to external force applied to a muscle spindle, a Golgi tendon organ, a muscle, a tendon, a ligament, and the like, but in a case in which the compression is performed in advance, it is possible to prevent the aforementioned injuries.

For a manual therapeutic technique of physiotherapy or a manipulative therapy of osteopathy, there are operational techniques for treating various types of muscle fasciae and joints, such as an indirect method and a direct method.

The indirect method is a therapeutic concept that is most importantly used in the osteopathy, the indirect method is a method of inducing a direction in which the joint is misaligned or a portion in which the joint is compressed to a direction in which the joint is further misaligned or compressed, and the indirect method corresponds to the compression, and the direct method is a method of inducing a direction opposite to a direction in which the joint is misaligned, and the direct method corresponds to the traction.

According to the lower body and spine joint moving device for restoring bodily balance and the control method therefor according to the exemplary embodiment of the present invention, it is possible to perform both of the indirect method and the direct method. A control unit 90 to be described below controls the actuator 80 in order to form a repetitive pattern of the indirect method and the direct method.

In a case in which the direct method such as the traction and the decompression is performed immediately during the treatment, a resistance reaction generally occurs in the body, and thus treatment efficiency inevitably deteriorates. However, when the treatment is performed by appropriately using the indirect method and the direct method, a stimulated reaction of a proprioreceptor, which detects a motion and a position of the human body, is actively performed, a centripetal signal is smoothly transmitted to the brain such that the brain is activated, and the brain sends a centrifugal signal such that a normal feedback signal neurotransmission system of the human body is properly adjusted, thereby inducing overall body balance. Therefore, the position of the joint and the balance of the muscle fascia are properly adjusted while repetitive exercise is performed by sending an indirect signal through the compression and sending a direct signal through the traction.

In comparison with a moving device in the related art, the lower body and spine joint moving device for restoring bodily balance and the control method therefor according to the exemplary embodiment of the present invention use both of the indirect method and the direct method in order to perform a softer, non-invasive, safe, and effect treatment. That is, a repetitive pattern of the indirect method and the direct method is made so that a portion to be treated is selectively and effectively treated by using an osteopathic method without putting stress on a patient. In addition, according to the lower body and spine joint moving device for restoring bodily balance according to the exemplary embodiment of the present invention, the compression may be performed on the ligament so that the brain may recognize a joint position. That is, the joint is ready to be restored to a proper position, and when the traction is subsequently performed on the ligament, the joint is naturally restored to the proper position.

Meanwhile, because of the extension and contraction of the bed 10 and fixing force of the binding unit 70, the same effect occurs not only on the coxal ligament, but also on the knee ligament and the spinal ligament. Therefore, the joints of the whole body are positioned in place, and as a result, the user may restore bodily balance.

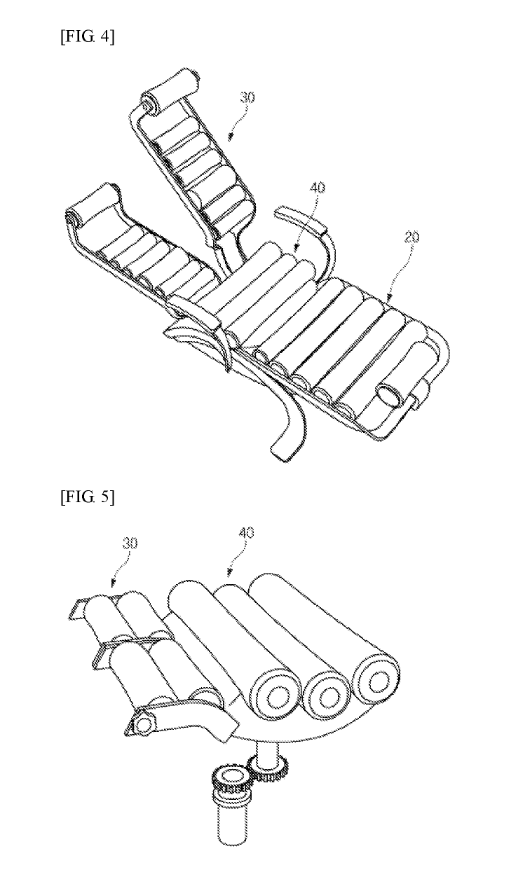

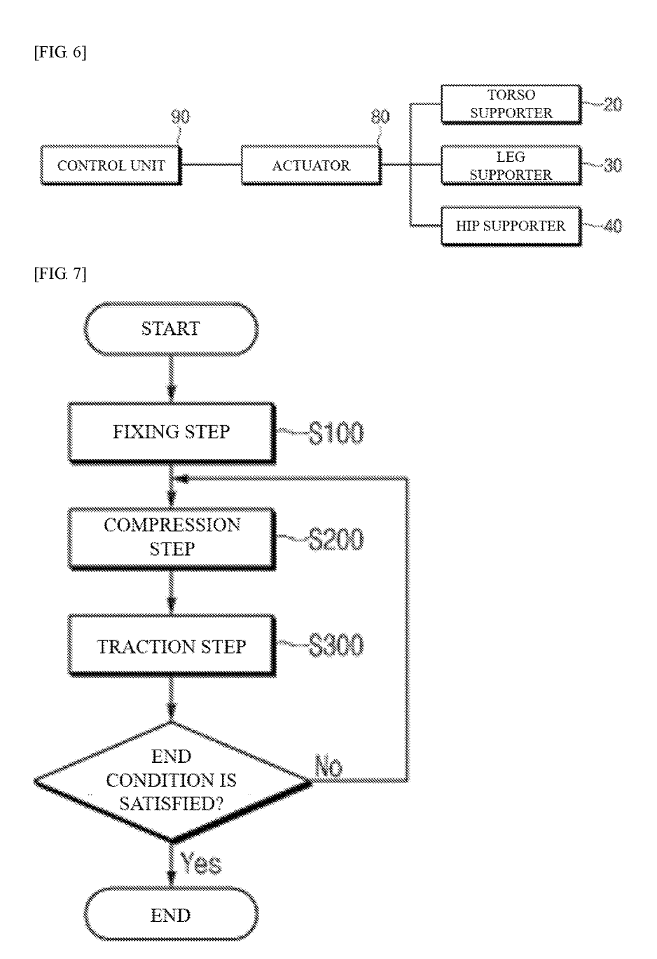

FIG. 4 is a perspective view of leg supporters according to the exemplary embodiment of the present invention. FIG. 5 is a perspective view illustrating a pivotal movement of the leg supporter according to the exemplary embodiment of the present invention. FIG. 6 is a view illustrating rotations of a hip supporter and the leg supporter according to the exemplary embodiment of the present invention.

Referring to FIGS. 4 to 6, the lower body and spine joint moving device for restoring bodily balance according to the exemplary embodiment of the present invention includes lower fixing units 73 which fix the user's lower body, an upper fixing unit 71 which fixes the user's upper body, and the bed 10 which is configured such that the lower fixing units 73 and the upper fixing unit 71 are fixed to the bed 10, the user may lie on the bed 10, and the bed 10 to which the lower fixing units 73 and the upper fixing unit 71 are fixed, which may be extended and contracted so that an interval between the lower fixing units 73 and the upper fixing unit 71 are repeatedly increased and decreased, and on which the user may lie.

The upper fixing unit 71 is disposed at an upper side of the user's coxae, and the lower fixing units 73 are disposed at a lower side of the user's coxae. The upper fixing unit 71 is disposed at the user's armpit and fixes the user's chest. The binding unit 70 includes members such as straps for fixing the user. The binding unit 70 includes the lower fixing units 73 which are coupled to pivoting units 35 and fix the user's lower body to the pivoting units 35. The lower fixing units 73 include shin fixing units 73b which fix the user's shins, and ankle fixing units 73a which fix the user's ankles.

The binding unit 70 includes the upper fixing unit 71 which is coupled to a torso supporter 20 and fixes the user's upper body to the torso supporter 20. The upper fixing unit 71 fixes the user by surrounding the user's waist or the user's armpit. The binding unit 70 fixes the user, and the user receives compressive force and tensile force together with the bed 10. Therefore, a plurality of binding units 70 may be formed.

The bed 10 includes the torso supporter 20 which supports the user's torso, and leg supporters 30 which support the user's legs and adjust an angle. The torso includes a portion above the human's waist and may include the head. The leg means a portion below the human's coxae. The torso supporter 20 supports the upper body and the head above the waist. The leg supporters 30 support the thighs and the calves, and may be formed to extend to the ankle.

The bed 10 includes a hip supporter 40 which is disposed between the torso supporter 20 and the leg supporters 30 and supports the user's hips, and a main supporter 50 which is disposed at a lower side of the hip supporter 40 and supports the user's load. The hip supporter 40 is formed at a lower side in a longitudinal direction of the torso supporter 20. That is, the torso supporter 20 supports the upper body above the waist, and the hip supporter 40 supports the hips below the waist.

The main supporter 50 is disposed at the lower side of the hip supporter 40, and may support loads of the torso supporter 20, the leg supporters 30, and the hip supporter 40. The torso supporter 20, the leg supporter 30, and the hip supporter 40 are connected to one another, and the main supporter 50 may be disposed at lower ends of connection points.

Each of the leg supporters 30 includes an extending part 31 which supports the user's leg and is extended and contracted in the longitudinal direction, and a curving part 33 which forms a curvature and converts a longitudinal motion into a rotational motion of the extending part 31. The curving part 33 is formed to be insertable between the hip supporter 40 and the leg supporters 30.

The lower body and spine joint moving device for restoring bodily balance according to the exemplary embodiment of the present invention includes the pivoting units 35 which support the user's calves and may be pivotally moved, and the extending parts 31 are connected to the pivoting units 35 and support the user's thighs. One end of the extending part 31 is connected to the pivoting unit 35, and the other end of the extending part 31 is connected to the curving part 33. The curving part 33 and the extending part 31 may be integrally formed. The curving part 33 forms a virtual rotation axis, and thus the rotation axis of the curving part 33 does not interfere with the user. A rack 33a may be formed on an inner circumferential surface or an outer circumferential surface of the curving part 33. A pinion (not illustrated), which is supplied with power from the actuator 80, may be disposed at a lower side of the hip supporter 40, and a rotational motion of the pinion may be transmitted to the rack 33a and transmitted to the leg supporter 30.

The main supporter 50 is connected to the leg supporters 30 or the hip supporter 40 so that the leg supporters 30 may be pivoted in left and right directions of the user. A gear may be formed at a lower side of the curving part 33 of the leg supporter 30 and may be supplied with rotational force. The leg supporters 30 and the hip supporter 40 may be integrally rotated. That is, the leg supporters 30 and the hip supporter 40 may be rotated together in the left and right directions of the user.

The leg supporters 30 are formed to be divided so as to support the user's two legs, respectively, and angles of the divided leg supporters 30 may be set to be different from each other. The leg supporters 30 are divided, and may maintain different angles. One of the leg supporters 30 may form a straight line with the torso supporter 20, and the other leg supporter 30 may be formed to be inclined with respect to the torso supporter 20. The curving parts 33 are formed to be divided at end portions of the leg supporters 30. The lower body and spine joint moving device for restoring bodily balance according to the exemplary embodiment of the present invention includes compressing units 60 which are connected to the end portions of the leg supporters 30 and disposed to face the user's soles.

The compressing units 60 are moved together with the leg supporters 30 when the leg supporters 30 are extended and contracted. When the leg supporter 30 is moved so that a length thereof is decreased, the compressing unit 60 compresses the user by pushing the user's sole. The traction may be performed by the binding unit 70, and the compression may be performed by the compressing units 60.

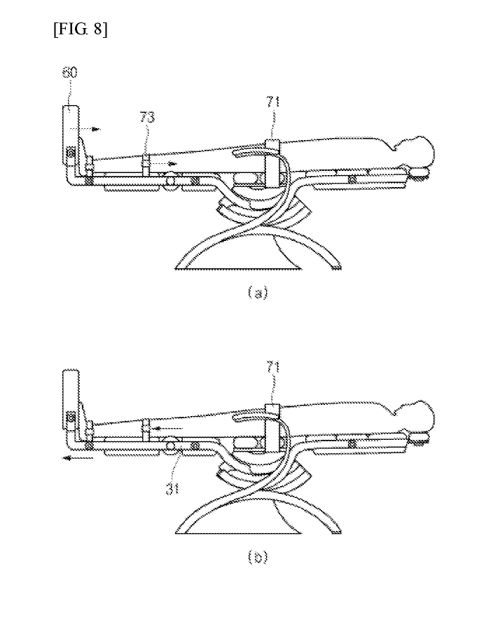

FIG. 7 is a flowchart illustrating a method of controlling the lower body and spine joint moving device for restoring bodily balance according to the exemplary embodiment of the present invention. FIG. 8 is a side view illustrating operations in a compression step and a traction step according to FIG. 7.

Referring to FIGS. 7 and 8, the method of controlling the lower body and spine joint moving device for restoring bodily balance according to the exemplary embodiment of the present invention includes a fixing step S100 which fixes the user to the bed 10, a compression step S200 which applies compressive force to the user lying on the bed 10 by decreasing a length of the bed 10, and a traction step S300 which applies tensile force to the user lying on the bed 10 by increasing a length of the bed 10 after the compression step S200. The control unit 90 may operate the actuator 80 in order to adjust a length and a rotation of the bed 10.

A plurality of actuators 80 may be provided, such that any one of the actuators 80 adjusts a pivotal movement of a lower body support portion in up and down directions, and another actuator 80 may adjust a pivotal movement of the lower body support portion in the left and right directions. In addition, still another actuator 80 may adjust a length of the lower body support portion. The number of actuators 80 may vary in accordance with exemplary embodiments.

When the user lies on the bed 10, the user is fixed to the bed 10 by using the binding unit 70. The lower fixing units 73 may fix the user's ankles and/or shins. The lower fixing units 73 may include the ankle fixing units 73a which fix the ankles, and the shin fixing units 73b which fix the shins. The upper fixing unit 71 is disposed at the user's waist and/or armpit, and may fix the user's chest.

When the user is fixed, the control unit 90 performs the compression step S200 first. The compression step S200 is performed to decrease a length of the bed 10, and the user receives compressive force. That is, the user is compressed.

When the user's body is compressed, the brain recognizes the compression of the body through the receptors present in the body. The brain commands the muscles to be extended in order to restore the compressed body to an original state.

In consideration of the aforementioned mechanism of the human body, the control unit 90 controls the actuator 80 so that the traction occurs after the compression. That is, the control unit 90 predicts a state in which the extension command is generated by the brain, and operates the actuator 80 so that the bed 10 is extended. A step, in which the bed 10 is extended as described above, is referred to as the traction step S300. When the traction step S300 is performed after the compression step S200, the traction occurs in a state in which the body is ready to be extended in advance, so that an adverse reaction such as stretching of the ligament is reduced, thereby protecting the body. In addition, because the body is ready to autonomously extend, the traction amount of the muscles is increased. Therefore, a stretching effect is further increased.

In addition, the proprioreceptor, which recognizes a position, continuously receives stimuli, such that the body autonomously finds balance. That is, the joint is moved to a normal position, such that an interval and a position of the joint are balanced. The actuator 80 alternately applies compressive force and tensile force to the user's coxa. Because the actuator 80 extends and contracts the bed 10, the user fixed to the bed 10 may alternately and repeatedly receive the tensile force and the compressive force. That is, the actuator 80 changes a direction of generated power so that the compression and the traction are repeated. For example, in a case in which the actuator 80 is a motor, a rotation direction of the actuator 80 is alternately changed.

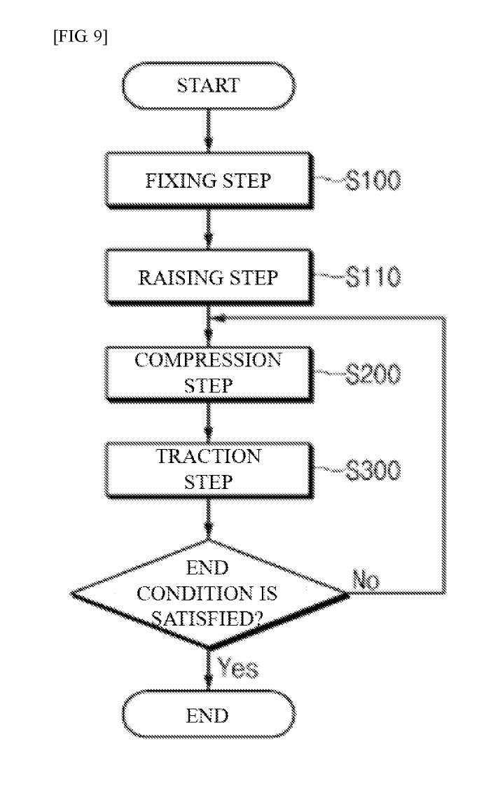

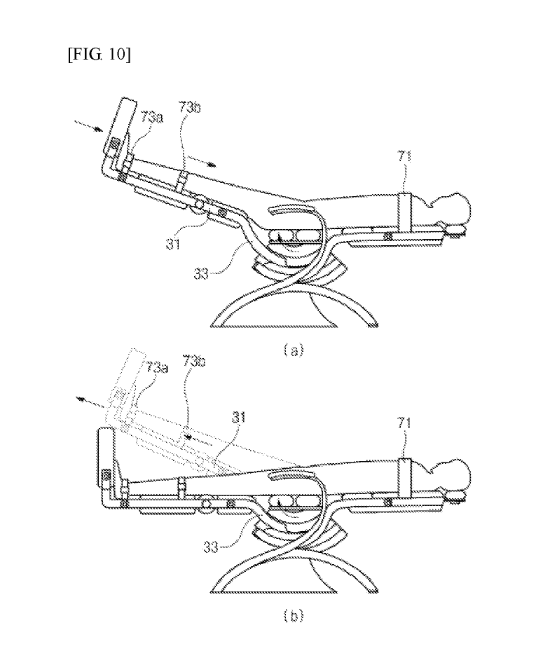

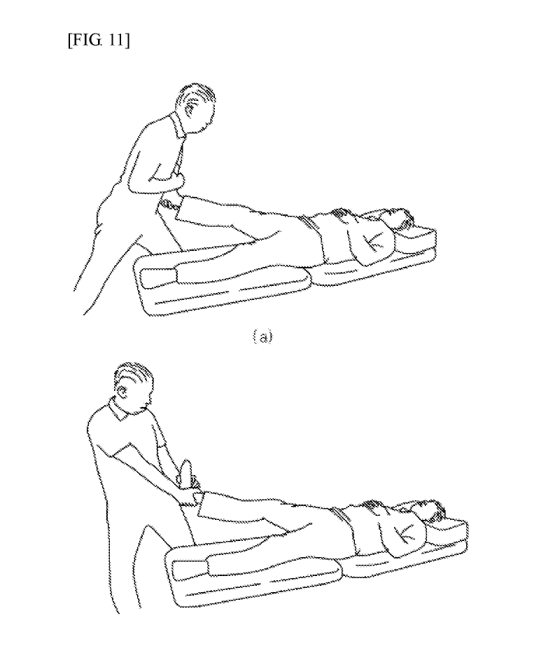

FIG. 9 is a flowchart illustrating a method of controlling the lower body and spine joint moving device for restoring bodily balance according to another exemplary embodiment of the present invention. FIG. 10 is a side view illustrating operations in a compression step and a traction step according to FIG. 9. FIG. 11 is a view illustrating an operation that needs to be performed at the time of manipulative therapy in order to obtain the same effect as the effect obtained by the operation in FIG. 10. Referring to FIGS. 9 to 11, the method of controlling the lower body and spine joint moving device for restoring bodily balance according to the exemplary embodiment of the present invention includes a raising step S110 which is performed after the fixing step S100 and before the compression step S200, and bends the bed 10 so that the user's legs are raised toward a front side of the user. The raising step S110 is performed after the fixing step S100. The raising step S110 is a step of raising the user's legs. With the raising step S110, it is possible to reduce a load applied to the user's upper body, and increase compression and traction efficiency in respect to the coxae.

An angle of the leg supporter 30 may be adjusted, and the angle may be adjusted as the leg supporter 30 is moved in the up and down directions or in the left and right directions. That is, the torso supporter 20 and the leg supporters may not be disposed on a straight line. With the adjustment of the angle of the leg supporter 30, a load, which is applied to the torso due to the binding unit 70, may be reduced when the compression and the traction are performed on a leg portion. That is, when the leg supporter 30 is extended and contracted, directions of the compression and traction include components in the gravitational direction, such that a more convenient exercise is enabled because the leg supporter 30, together with the torso supporter 20, receives pressure applied to the user.

That is, the aforementioned control operation performs the same function as a procedure of an expert manipulative therapist as illustrated in FIG. 11, and as a result, the user may restore bodily balance by means of the control operation as described in the exemplary embodiment of the present invention without the help of the expert manipulative therapist.

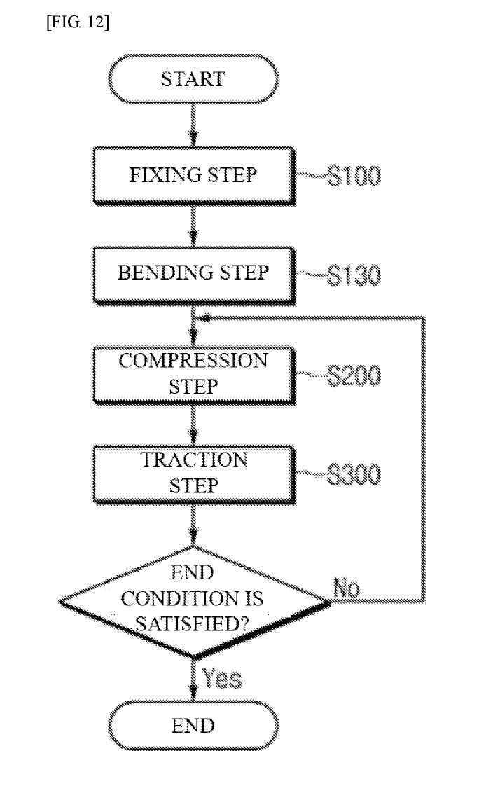

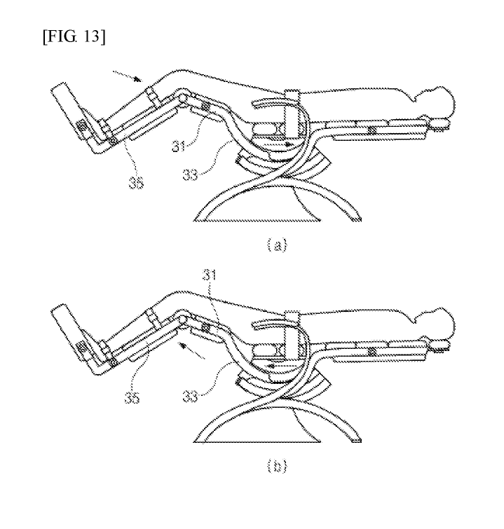

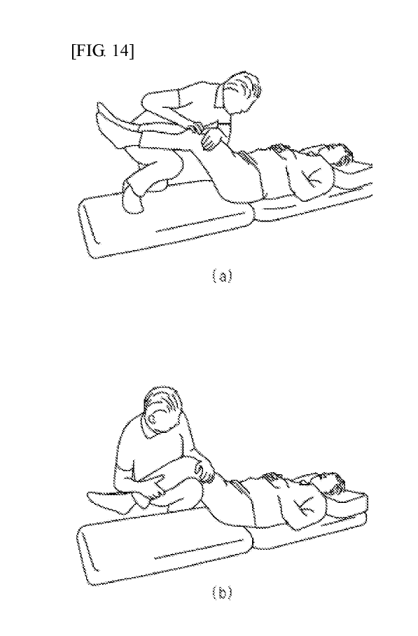

FIG. 12 is a flowchart illustrating a method of controlling a lower body and spine joint moving device for restoring bodily balance according to still another exemplary embodiment of the present invention. FIG. 13 is a side view illustrating operations in a compression step and a traction step according to FIG. 12. FIG. 14 is a view illustrating an operation that needs to be performed at the time of manipulative therapy in order to obtain the same effect as the effect obtained by the operation in FIG. 13.

Referring to FIGS. 12 and 13, the method of controlling the lower body and spine joint moving device for restoring bodily balance according to the exemplary embodiment of the present invention includes a bending step S130 which is performed after the fixing step S100 and before the compression step S200 and bends the bed 10 so that the user's knee is bent. The bending step S130 may be performed by means of the pivotal movement of the pivoting unit 35. The pivoting unit 35 is connected to the extending part 31. However, a length of the pivoting unit 35 may be increased or decreased in the longitudinal direction in accordance with the exemplary embodiment. In the case in which the bending step S130 is added, the coxae may be concentratedly stretched.

That is, the aforementioned control operation performs the same function as a procedure of an expert manipulative therapist as illustrated in FIG. 14, and as a result, the user may restore bodily balance by means of the control operation as described in the exemplary embodiment of the present invention without the help of the expert manipulative therapist.

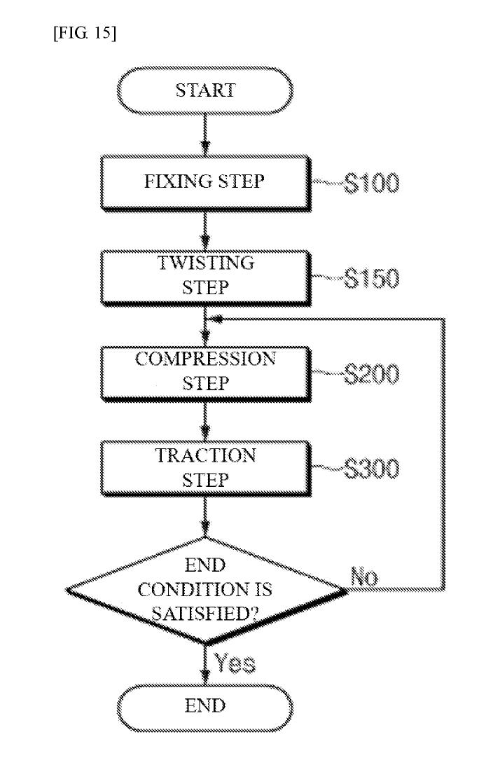

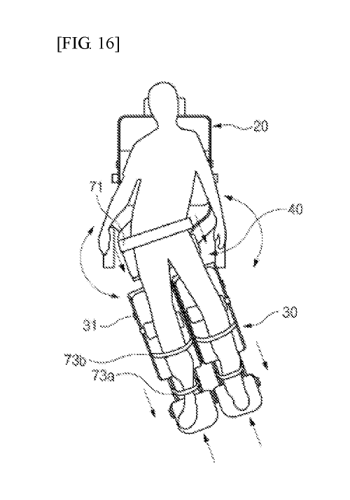

FIG. 15 is a flowchart illustrating a method of controlling a lower body and spine joint moving device for restoring bodily balance according to yet another exemplary embodiment of the present invention. FIG. 16 is a top plan view illustrating operations in a compression step and a traction step according to FIG. 15.

Referring to FIGS. 15 and 16, the method of controlling the lower body and spine joint moving device for restoring bodily balance according to the exemplary embodiment of the present invention includes a twisting step S150 which is performed after the fixing step S100 and bends the bed 10 so that the user's lower body and the user's upper body face different directions. The twisting step S150 is performed after the fixing step S100. During the twisting step S150, the hip supporter 40 and the leg supporter 30 are rotated in the left or right directions. The twisting step S150 performs the traction on the user's upper body and the user's flank, thereby providing a stretching effect.

The raising step S110 and the twisting step S150 may be performed before or after the compression step S200 and the traction step S300, and the number of times for performing the raising step S110 and the twisting step S150 may be more than one. The number of times for performing the raising step S110 and the twisting step S150 may vary in accordance with the user's setting and a predetermined program.

The method of controlling the lower body and spine joint moving device for restoring bodily balance according to the exemplary embodiment of the present invention performs the compression step S200 and the traction step S300 while maintaining the bending step S130.

The method of controlling the lower body and spine joint moving device for restoring bodily balance according to the exemplary embodiment of the present invention performs the compression step S200 and the traction step S300 on the joint. In more detail, states of the knee joint may be divided into a closed state in which the knee is spread, and an opened state in which the knee is bent. The closed state refers to a state in which the ligament and the joint are tautly pulled to provide stability to the joint, and an additional motion is minimized. The opened state refers to a state in which the ligament and the joint are loosened, and an additional motion is enabled. Therefore, according to the present invention, the compression step and the traction step are performed in the opened state (joint open pack position) in which the joint and the ligament are loosened, and as a result, the mechanoreceptor of the joint effectively receives stimuli.

The lower body and spine joint moving device for restoring bodily balance and the control method therefor according to the present invention, which have been described above, increase flexibility of the posture maintaining muscle, that is, the concentric muscle which has deteriorated, and helps the user to maintain a proper posture.

In addition, it is possible to solve musculoskeletal pain such as back pain, pelvic pain, sciatica, piriformis syndrome, knee arthritis, neck pain, and chest pain, and musculoskeletal disorders such as spinal scoliosis, thoracic kyphosis, lumbar lordosis, genu varum (O-shaped leg), knock-knee (X-shaped leg), a length difference between lower limbs caused by a twisted pelvis, and anteversion and retroversion of the coxae. In addition, it is possible for the user to conveniently perform physiotherapy without applying artificial force.

While the exemplary embodiments of the present invention have been illustrated and described above, the present invention is not limited to the aforementioned specific exemplary embodiments, various modifications may be made by a person with ordinary skill in the art to which the present invention pertains without departing from the subject matters of the present invention that are claimed in the claims, and these modifications should not be appreciated individually from the technical spirit or prospect of the present invention.

1. A lower body and spine joint moving device for restoring bodily balance, the lower body and spine joint moving device comprising:
a bed which includes a torso supporter for supporting a user's torso and leg supporters for supporting the user's legs;
a binding unit which fixes the user to the bed; and
an actuator which generates power for extending and contracting the bed,
wherein each of the leg supporters includes an extending part which supports the user's leg and is extended and contracted in a longitudinal direction, and a curving part which forms a curvature and converts a movement in the longitudinal direction into a rotational motion of the extending part.

2. The lower body and spine joint moving device of claim 1, wherein the actuator alternately applies compressive force and tensile force to the user's lower limb joint and spine.

3. The lower body and spine joint moving device of claim 1, wherein the bed actuator repeatedly changes a direction of power and repeatedly applies tensile force and compressive force to the user fixed by the binding unit.

4. The lower body and spine joint moving device of claim 1, further comprising:
a main supporter which supports a load of the bed,
wherein the bed further includes a hip supporter which is disposed between the torso supporter and the leg supporters and supports the user's hips, and the curving part is formed to be insertable into a lower side of the hip supporter.

5. A method of controlling a lower body and spine joint moving device for restoring bodily balance which includes a bed that includes a torso supporter for supporting a user's torso, and leg supporters for supporting the user's legs and capable of being bent at a knee position, a binding unit that fixes the user to the bed, and an actuator that generates power for extending and contracting the bed, the method comprising:
a fixing step of fixing the user to the bed with the binding unit;
a bending step of bending the leg supporters in order to bend the user's knee;
a compression step of applying compressive force to the user lying on the bed by decreasing a length of the bed while maintaining the bending step; and
a traction step of applying tensile force to the user lying on the bed by extending a length of the bed while maintaining the bending step after the compression step.

6. A method of controlling a lower body and spine joint moving device for restoring bodily balance which includes a bed that includes a torso supporter for supporting a user's torso, and leg supporters for supporting the user's legs and capable of being bent at a knee position, a binding unit that fixes the user to the bed, and an actuator that generates power for extending and contracting the bed, the method comprising:
a fixing step of fixing the user to the bed with the binding unit;
a raising step of raising the leg supporter so that the user's leg is raised toward a front side of the user;
a bending step of bending the leg supporters in order to bend the user's knee;
a compression step of applying compressive force to the user lying on the bed by decreasing a length of the bed while maintaining the raising step and the bending step; and
a traction step of applying tensile force to the user lying on the bed by extending a length of the bed while maintaining the raising step and the bending step after the compression step.
